(19) United States
(12) Patent Application Publication
(10) Pub. No.: US 2024/0332862 A1
(43) Pub. Date: Oct. 3, 2024

(54) Connector and Connector Assembly

(71) Applicant: Tyco Electronics (Shanghai) Co., Ltd., Shanghai (CN)

(72) Inventors: Jiaoyong (Mac) Liu, Shanghai (CN); Jie (Roger) Luo, Shunde (CN); Hongqiang (Sean) Han, Shanghai (CN)

(73) Assignee: Tyco Electronics (Shanghai) Co., Ltd., Shanghai (CN)

(21) Appl. No.: 18/625,335

(22) Filed: Apr. 3, 2024

(30) Foreign Application Priority Data
Apr. 3, 2023 (CN) 202310348376.0

(51) Int. Cl. H01R 13/631; H01R 13/18; H01R 13/193

(52) U.S. Cl. CPC H01R 13/6315; H01R 13/18; H01R 13/193

(57) ABSTRACT

A connector comprises a housing, a pair of terminals arranged in the housing, and a pair of connecting members. The housing includes a pair of side walls opposite one another in a transverse direction of the housing, with each side wall having an elastic arm. The pair of terminals face each other in the transverse direction, and have inner sides facing each other and outer sides opposite to each other in the transverse direction. The elastic arms on the outer sides of the pair of terminals and bias the pair of terminals into electrical contact with a mating terminal inserted therebetween. The pair of connecting members rotatably connect the pair of terminals to the housing such that the terminal can be rotated about an axis of the connecting member. The axis of the connecting member extends along a height direction of the housing.

### CROSS-REFERENCE TO RELATED APPLICATION

This application claims the benefit of Chinese Patent Application No. CN202310348376.0 filed on Apr. 3, 2023, in the State Intellectual Property Office of China, the whole disclosure of which is incorporated herein by reference.

### FIELD OF THE INVENTION

The present invention relates to a connector and a connector assembly including the connector.

### BACKGROUND

In the prior art, the power supply unit of the data center is electrically connected to metal bars of an associated cabinet through connectors. In order to improve the current transmission capacity of the connector, in the prior art, the terminals of the connector usually adopt multi-layer interleaved overlapping terminals. That is, the terminals include multiple terminal laminations stacked on top and bottom. Each terminal lamination is not only used for transmitting current, but also has an elastic structure for providing elastic contact force. However, this results in a structure of the terminal lamination that is complex, difficult to manufacture, and can also lead to excessive insertion force when inserting mating terminals. Usually, the insertion force of the mating terminal is proportional to the third power of the thickness of the connector terminal.

In the prior art, there are situations of offset mating and tilt mating between the mating terminals and the connector terminals. However, the floating contact performance of existing connectors is typically poor. When offset mating or tilt mating occurs, the terminal at one side of the connector is subjected to a large force, while the terminal at the other side is subjected to a small force, even without contact. Especially in extreme offset mating or extreme tilt mating, this problem is more serious, greatly affecting product performance, leading to high and unstable contact impedance of connector products, and reducing the current carrying capacity of connector products.

### SUMMARY

According to one embodiment of the present disclosure, a connector comprises a housing, a pair of terminals arranged in the housing, and a pair of connecting members. The housing includes a pair of side walls opposite one another in a transverse direction of the housing, with each side wall having an elastic arm. The pair of terminals face each other in the transverse direction of the housing, and have inner sides facing each other and outer sides opposite to each other in the transverse direction. The elastic arms of the pair of side walls respectively press on the outer sides of the pair of terminals and are adapted to bias the pair of terminals into electrical contact with a mating terminal inserted therebetween. The pair of connecting members rotatably connect the pair of terminals to the housing such that the terminal can be rotated about an axis of the connecting member. The axis of the connecting member extends along a height direction of the housing.

### BRIEF DESCRIPTION OF THE DRAWINGS

The invention will now be described by way of example with reference to the accompanying Figures, of which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows a vertical sectional view of a connector according to an exemplary embodiment of the present invention;

FIG. 4 shows a horizontal sectional view of a connector according to an exemplary embodiment of the present invention;

FIG. 5 shows a cross-sectional view of a connector according to an exemplary embodiment of the present invention;

FIG. 6 shows an illustrative perspective view of a pair of terminal laminations of a connector according to an exemplary embodiment of the present invention;

FIG. 7 shows an illustrative perspective view of a connector housing according to an exemplary embodiment of the present invention;

FIG. 8 shows an illustrative perspective view of a connector and a mating terminal according to an exemplary embodiment of the present invention;

FIG. 9 shows a horizontal sectional view of a connector and a mating terminal according to an exemplary embodiment of the present invention;

FIG. 10 shows an illustrative perspective view of a connector assembly according to an exemplary embodiment of the present invention;

FIG. 11 shows an illustrative exploded view of a connector assembly according to an exemplary embodiment of the present invention;

FIG. 12 shows a horizontal sectional view of a connector assembly according to an exemplary embodiment of the present invention;

FIG. 13 shows a horizontal cross-sectional view of a connector assembly according to an exemplary embodiment of the present invention, wherein the terminals float in the housing of the connector; and

FIG. 14 shows a horizontal cross-sectional view of a connector assembly according to an exemplary embodiment of the present invention, wherein the connector floats in an insulation housing of the connector assembly.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A connector according to an embodiment of the present disclosure comprises a housing having a top wall and a bottom wall opposite in its height direction, as well as a pair of side walls opposite in its transverse direction. A pair of terminals are arranged in the housing and face each other in the transverse direction of the housing. A pair of connecting members are provided for respectively rotatably connecting the pair of terminals to the housing, so that the terminal can be rotated about an axis of the connecting member. The pair of terminals have inner sides facing each other and outer sides opposite to each other in the transverse direction of the housing, and the axis of the connecting member extends along a height direction of the housing. An elastic arm is formed on the side wall of the housing. The elastic arms of the pair of side walls are respectively pressed on the outer sides of the pair of terminals, so that the pair of terminals make reliable electrical contact with a mating terminal inserted between them.

According to embodiment, a connector assembly comprises an insulation housing having at least one containment chamber. At least one aforementioned connector is installed in at least one containment chamber of the insulation housing, respectively.

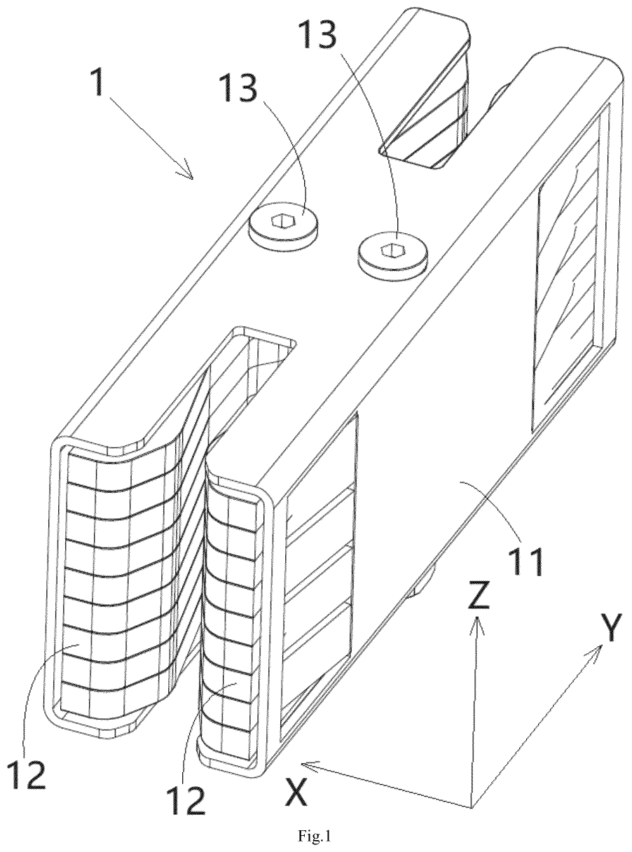

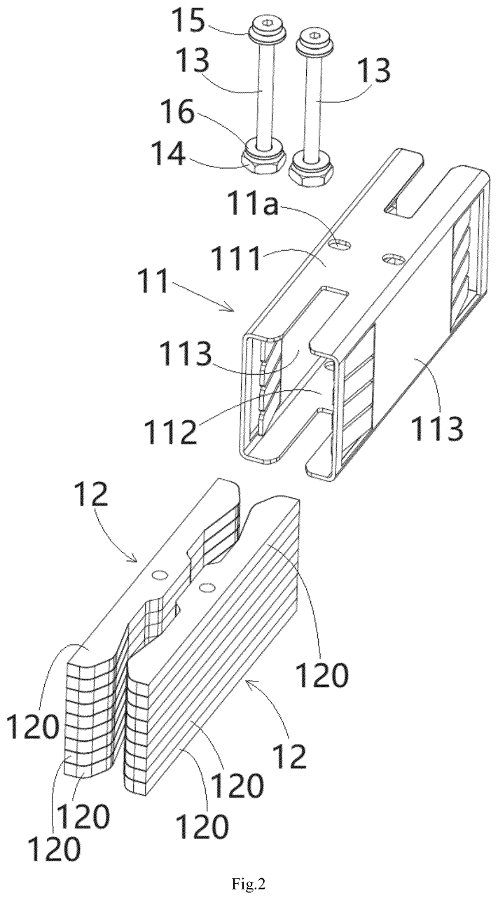

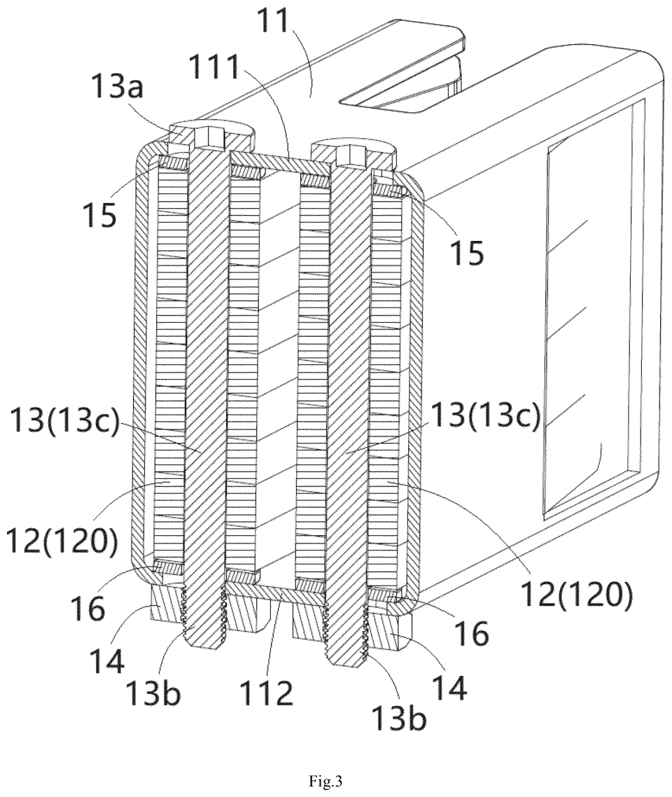

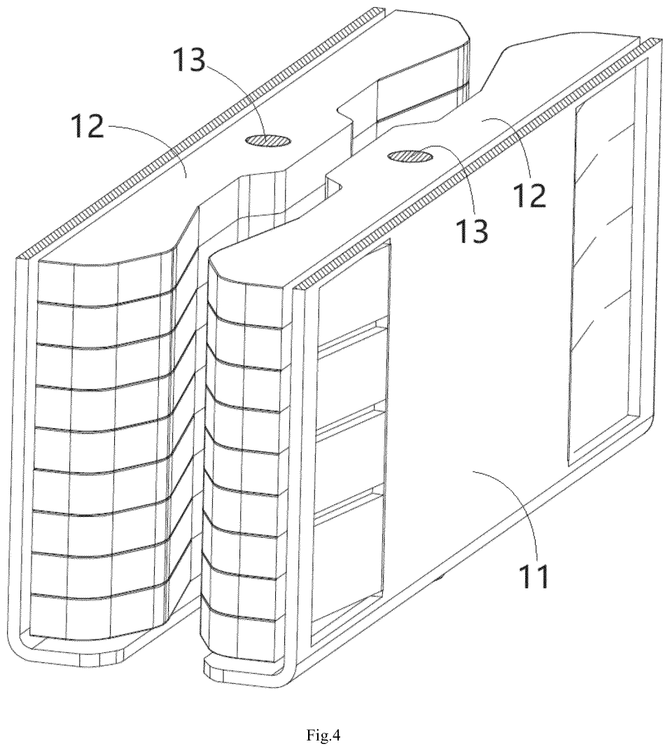

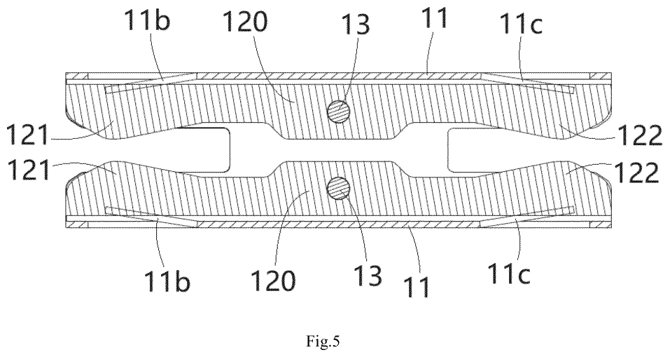

FIG. 1 shows an illustrative perspective view of a connector 1 according to an exemplary embodiment of the present invention. FIG. 2 shows a schematic diagram of the decomposition of the connector 1 according to an exemplary embodiment of the present invention. FIG. 3 shows a vertical sectional view of the connector 1 according to an exemplary embodiment of the present invention. FIG. 4 shows a horizontal sectional view of the connector 1 according to an exemplary embodiment of the present invention. FIG. 5 shows a cross-sectional view of the connector 1 according to an exemplary embodiment of the present invention.

As shown in FIGS. 1-5, in an exemplary embodiment of the present invention, the connector 1 mainly includes a housing 11, a pair of terminals 12, and a pair of connecting members 13. The housing 11 has a top wall 111 and a bottom wall 112 opposite in its height direction Z, as well as a pair of side walls 113 opposite in its transverse direction X. The pair of terminals 12 are arranged in the housing 11 and are opposite to each other in the transverse direction X of the housing 11. The pair of connecting members 13 respectively connect the pair of terminals 12 rotatably to the housing 11, allowing terminal 12 to rotate about the axis of connecting member 13.

The pair of terminals 12 have inner sides facing each other and outer sides opposite to each other in the transverse direction X of the housing 11, and the axis of the connecting member 13 extends along the height direction Z of the housing 11. Elastic arms 11b and 11c are formed on the side wall 113 of the housing 11. The elastic arms 11b and 11c on the pair of side walls 113 of housing 11 are respectively pressed on the outer sides of the end portions 121 and 122 of the pair of terminals 12, ensuring reliable electrical contact between the pair of terminals 12 and the mating terminal 10 and 20 inserted between them.

The terminal 12 can rotate around the axis of connecting member 13, resulting in improved floating contact performance of terminal 12. Therefore, the present invention can reduce the contact impedance of terminal 12 during offset mating and tilt mating, and improve the current carrying capacity of terminal 12 during offset mating and tilt mating, so that the terminal 12 can also make stable and reliable electrical contact with mating terminals 10 and 20 during offset mating and tilt mating, greatly improving the electrical connection performance of connector products.

In one embodiment, the terminal 12 is a rigid conductive component used only for transmitting current. Terminal 12 itself has no elastic structure, and the contact force between the terminal 12 and the mating terminal 10 and 20 is entirely provided by the elastic arms 11b and 11c on the housing 11. Therefore, the present invention simplifies the structure of terminal 12 and can greatly improve its current carrying capacity.

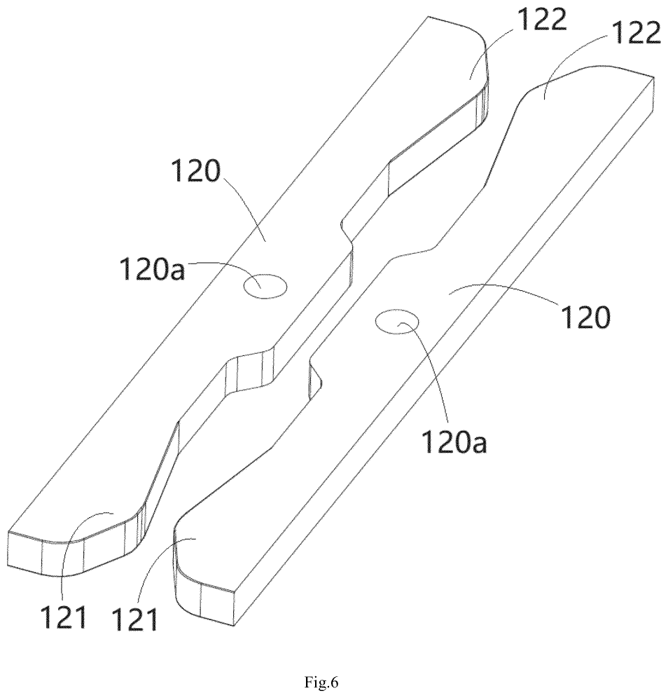

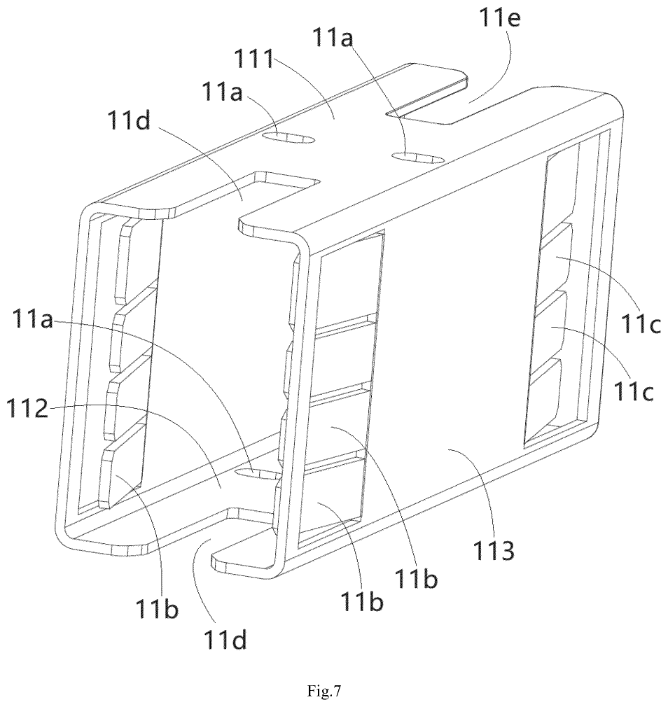

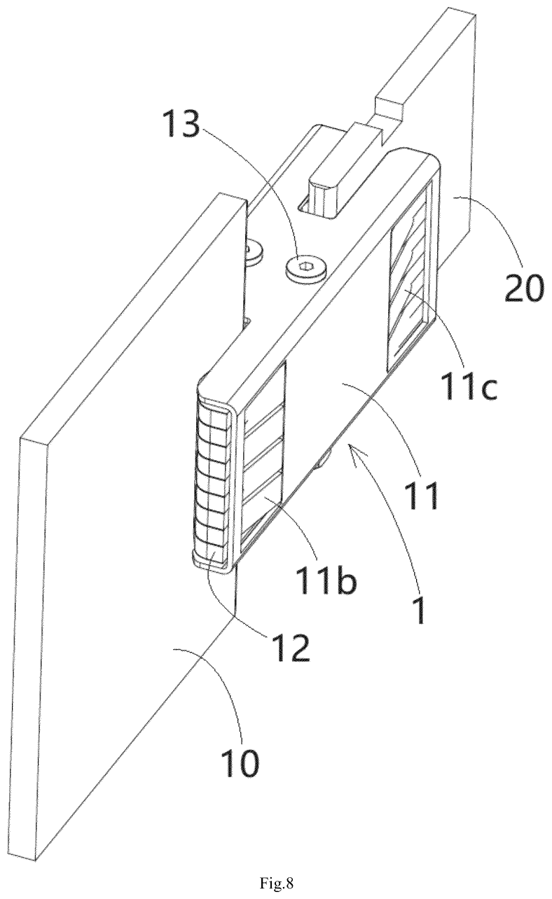

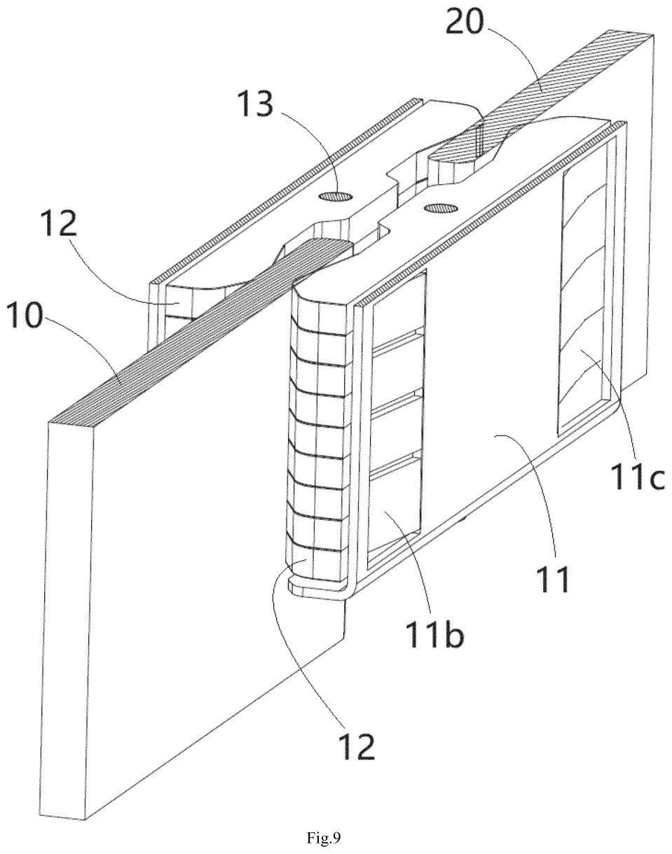

FIG. 6 shows an illustrative perspective view of a pair of terminal laminations 120 of the connector 1 according to an exemplary embodiment of the present invention. FIG. 7 shows an illustrative perspective view of the housing 11 of the connector 1 according to an exemplary embodiment of the present invention. FIG. 8 shows an illustrative perspective view of the connector 1 paired with mating terminals 10, 20 according to an exemplary embodiment of the present invention. FIG. 9 shows a horizontal sectional view of the connector 1 and paired terminals 10, 20 according to an exemplary embodiment of the present invention.

As shown in FIGS. 1-9, in the illustrated embodiments, the housing 11 has front and rear ports opposite to each other in its longitudinal direction Y. The terminal 12 includes a front end portion 121 and a rear end portion 122 located in the front and rear ports, respectively. The elastic arms 11b and 11c include a front elastic arm 11b and a rear elastic arm 11c corresponding to the front end portion 121 and rear end portion 122 of terminal 12, respectively. The front elastic arms 11b of the pair of side walls 113 of the housing 11 are respectively pressed on the outer sides of the front end portions 121 of the pair of terminals 12, and are adapted to apply a first contact pressure on the front end portions 121 of the pair of terminals 12, so that the front end portions 121 of the pair of terminals 12 can make reliable electrical contact with the first mating terminal 10 inserted between them. The rear elastic arms 11c of the pair of side walls 113 of the housing 11 are respectively pressed on the outer sides of the rear end portions 122 of the pair of terminals 12, and area adapted to apply a second contact pressure on the rear end portions 122 of the pair of terminals 12, so that the rear end portions 122 of the pair of terminals 12 can make reliable electrical contact with the second mating terminal 20 inserted between them.

In the illustrated embodiments, first avoidance grooves 11d are formed on the front sides of the top wall 111 and bottom wall 112 of the housing 11 to avoid or accept the two longitudinal side edges of the first mating terminal 10, allowing the first mating terminal 10 with a width greater than the height of the housing 11 to be inserted into the front port of the housing 11. Further, second avoidance grooves 11e are formed on the rear sides of the top wall 111 and bottom wall 112 of the housing 11 to avoid or accept the two longitudinal edges of the second mating terminal 20, allowing the second mating terminal 20 with a width greater than the height of the housing 11 to be inserted into the rear port of the housing 11.

The terminal 12 comprises multiple terminal laminations 120 stacked in the height direction Z of the housing 11. A through hole 120a is formed in the terminal lamination 120 that allows the connecting member 13 to pass through. The number and thickness of terminal laminations 120 in terminal 12 can be determined based on the amount of current that connector 1 needs to transmit. The number of terminal laminations 120 in terminal 12 is not less than three. In the illustrated embodiment, the number of terminal laminations 120 in terminal 12 is nine. However, the present invention is not limited to the illustrated embodiments, for example, the number of terminal laminations 120 in terminal 12 can be three, four, five, or more.

In the illustrated embodiments, slot holes 11a are formed on the top wall 111 and bottom wall 112 of the housing 11 to allow the connecting member 13 to pass through. The size of the slot hole 11a in the transverse direction X of the housing 11 is larger than the diameter of the connecting member 13 to allow the connecting member 13 to move relative to the housing 11 in the transverse direction X. This allows terminal 12 to float in the transverse direction X of housing 11, further improving the floating contact performance of terminal 12. This allows terminal 12 to make stable and reliable electrical contact with the mating terminals 10 and 20 during offset and tilt mating, greatly improving the electrical connection performance of connector products.

The connecting member 13 comprises a rotating shaft part 13c with smooth surface. The rotating shaft part 13c passes through the through-hole 120a in the terminal 12, allowing the terminal 12 to rotate around the rotating shaft part 13c. The connecting member 13 further comprises a head 13a and a threaded portion 13b located at both ends of the rotating shaft part 13c, respectively, and the connector 1 further comprises a nut 14 for connecting to the threaded portion 13b of the connecting member 13. The head 13a of connecting member 13 is positioned on the top wall 111 of housing 11, and the threaded portion 13b of connecting member 13 extends out from the bottom wall 112 of housing 11 and is threaded to the nut 14. In the illustrated embodiment, the nut 14 cannot be tightened to ensure that the terminal 12 and the connecting member 13 can float relative to housing 11.

The connector 1 further comprises an upper washer 15 and a lower washer 16. The upper washer 15 is installed on the rotating shaft part 13c of the connecting member 13 and is padded or arranged between the top wall 111 of the housing 11 and the top surface of the terminal 12. The lower washer 16 is fitted onto the rotating shaft part 13c of the connecting member 13 and is padded or arranged between the bottom wall 112 of the housing 11 and the bottom surface of the terminal 12. The upper washer 15 and lower washer 16 can reduce the gap between the top and bottom surfaces of terminal 12 and the top and bottom walls 111 and 112 of housing 11, in order to reduce the movement of terminal 12 in the height direction Z of housing 11.

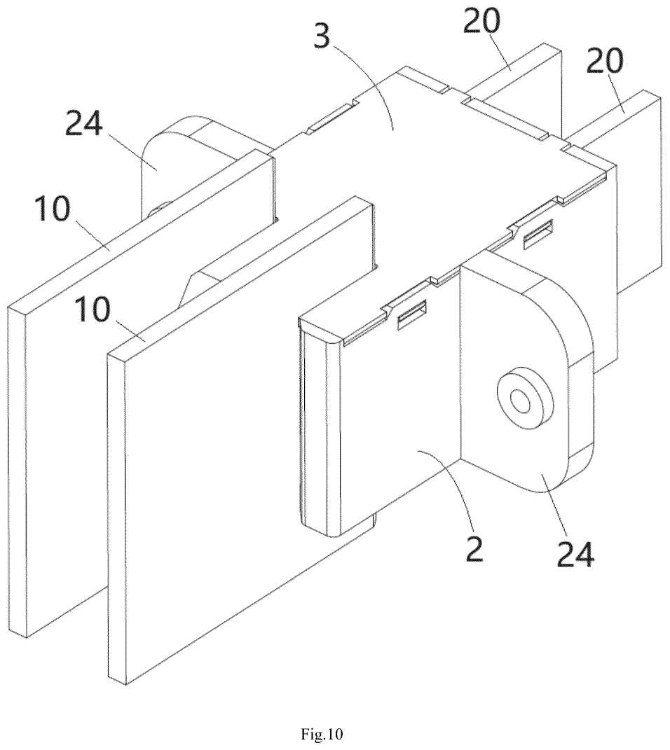

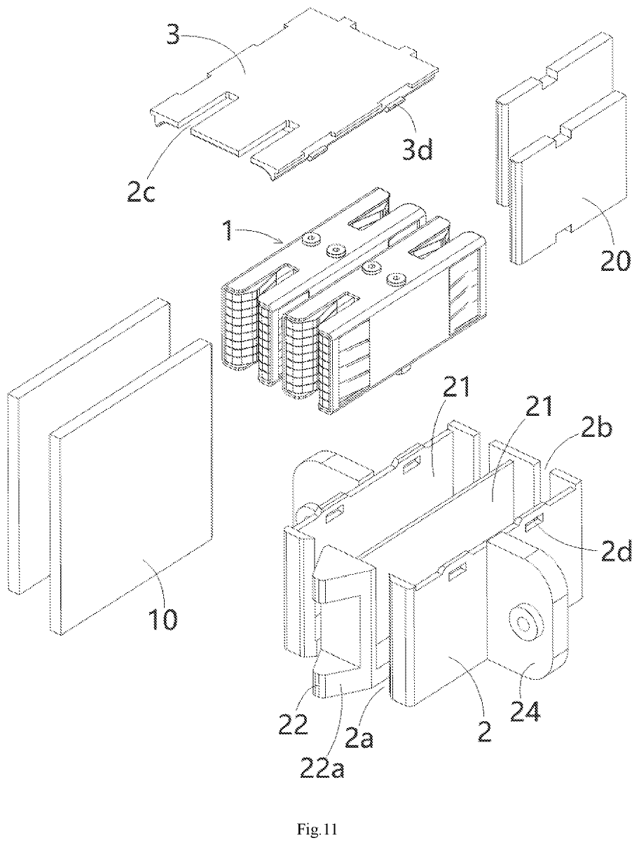

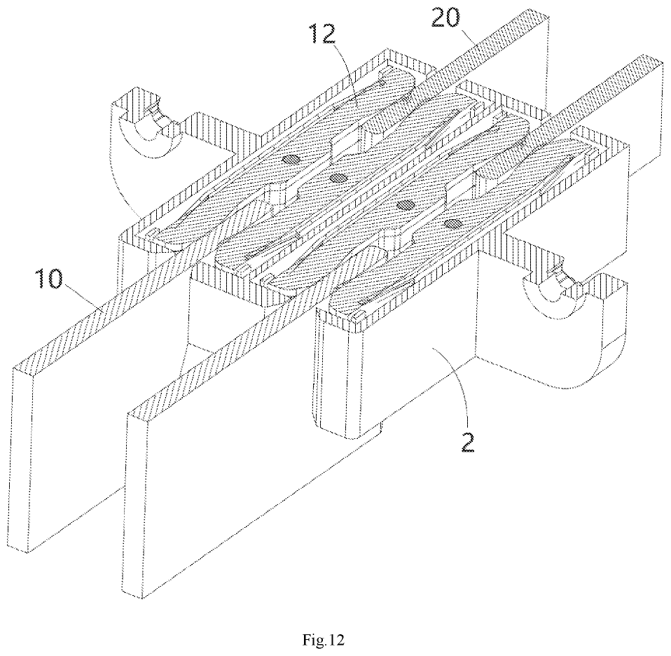

FIG. 10 shows an illustrative perspective view of a connector assembly according to an exemplary embodiment of the present invention. FIG. 11 shows an illustrative exploded view of a connector assembly according to an exemplary embodiment of the present invention. FIG. 12 shows a horizontal sectional view of a connector assembly according to an exemplary embodiment of the present invention.

As shown in FIGS. 1-12, in another exemplary embodiment of the present invention, a connector assembly is also disclosed. The connector assembly mainly includes an insulation housing 2 and at least one connector 1. The insulation housing 2 has at least one containment chamber 21. At least one connector 1 is respectively installed in at least one compartment 21 of the insulation housing 2. In the illustrated embodiment, the connector assembly comprises two connectors 1. The insulation housing 2 has two containment chambers 21 arranged side by side. Two connectors 1 are installed in two containment chambers 21 of the insulation housing 2. However, please note that the present invention is not limited to the illustrated embodiments. For example, the insulation housing 2 may also have on, three, or more containment chambers 21. When the insulation housing 2 has multiple containment chambers 21, the multiple containment chambers 21 can be arranged side by side in one or more rows.

The insulation housing 2 has front and rear walls opposite in its longitudinal direction Y. Two first openings 2a are formed on the front wall of the insulation housing 2, which are respectively connected to the two containment chambers 21, to allow the first mating terminal 10 matched with the front end of the connector 1 to be inserted into the containment chamber 21 through the first opening 2a. Two second openings 2b are formed on the rear wall of the insulation housing 2, which are respectively connected to the two containment chambers 21, to allow the second mating terminal 20 matched with the rear end of the connector 1 to be inserted into the containment chamber 21 through the second opening 2b.

The insulation housing 2 has a top opening, and the connector 1 is installed into the containment chamber 21 through the top opening. The connector assembly also includes a top cover 3, which is installed on the top opening of the insulation housing 2 to cover the top opening of the insulation housing 2. The insulation housing 2 has two opposite side walls in its transverse direction X. A snapping slots 2d is formed on each of the two side walls of the insulation housing 2. Protrusions 3d are respectively formed on both sides of the top cover 3. The protrusions 3d are respectively connected to the snapping slots 2d to fix the top cover 3 to the insulation housing 2.

Avoidance slots 2c are respectively formed on the bottom walls of the top cover 3 and the insulation housing 2, which are connected to the first opening 2a and extend a predetermined length along the longitudinal direction Y of the insulation housing 2. The avoidance grooves 2c are used to avoid or accommodate the two longitudinal side edges of the first mating terminal 10, allowing the first mating terminal 10 with a width greater than the height of the insulation housing 2 to be inserted into the containment chamber 21.

A protruding guide portion 22 is formed on the outer side of the front wall of the insulation housing 2. The guide portion 22 has a guide slope 22a, which is used to guide the first mating terminal 10 into the first opening 2a of the insulation housing 2. Two connecting ears 24 are formed on the outer sides of the two side walls of the insulation housing 2. The connecting ears 24 are used to connect to an installation panel to fix the insulation housing 2 thereto.

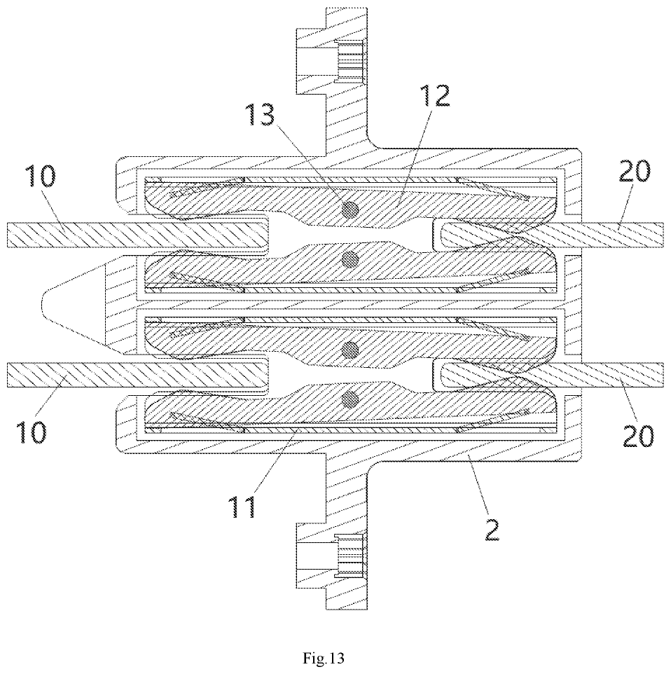

FIG. 13 shows a horizontal cross-sectional view of a connector assembly according to an exemplary embodiment of the present invention, wherein the terminal 12 is shown floating in the housing 11 of the connector. As shown in FIG. 13, in the illustrated embodiment, the terminal 12 can rotate around the axis of the connecting member 13 and move along the transverse direction X of the housing 11, allowing terminal 12 to float inside the housing 11 of connector 1. This improves the floating contact performance of terminal 12, allowing it to make stable and reliable electrical contact with the mating terminals 10 and 20 during offset mating and tilt mating, thereby improving the electrical connection performance of the connector product.

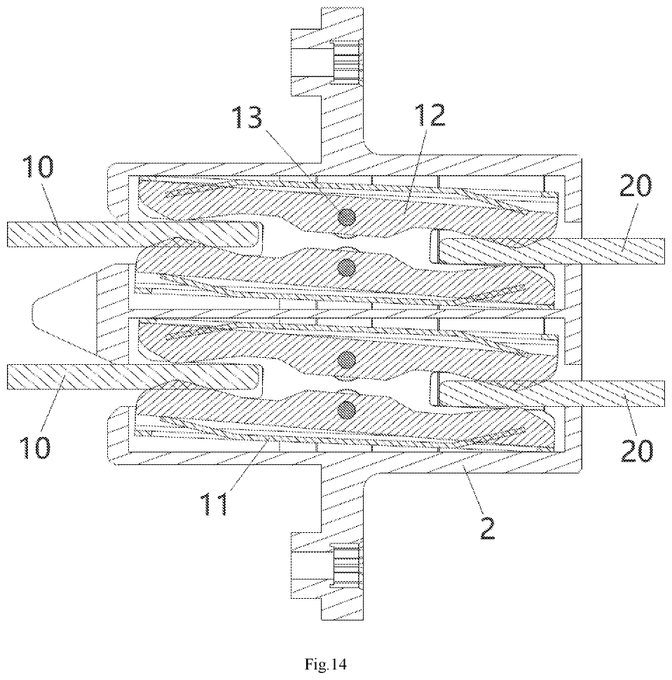

FIG. 14 shows a horizontal cross-sectional view of a connector assembly according to an exemplary embodiment of the present invention, wherein the connector 1 floats in the insulation housing 2 of the connector assembly. As shown in FIG. 14, in the illustrative example, the lateral size of the containment chamber 21 in the insulation housing 2 of the connector assembly is slightly larger than that of the housing 11 of the connector 1, allowing the connector 1 to float in the housing 21 of the insulation housing 2. This further improves the floating contact performance of terminal 12, allowing the terminal 12 to make stable and reliable electrical contact with the mating terminals 10 and 20 even in extreme offset mating and extreme tilt mating, greatly improving the electrical connection performance of connector products.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing, having:
a top wall;
a bottom wall opposite the top wall in a height direction of the housing; and
a pair of side walls arranged opposite one another in a transverse direction of the housing, each side wall having an elastic arm;
a pair of terminals arranged in the housing and facing each other in the transverse direction of the housing, the pair of terminals having inner sides facing each other and outer sides opposite to each other in the transverse direction, the elastic arms of the pair of side walls pressing on respective ones of the outer sides of the pair of terminals and are adapted to bias the pair of terminals into electrical contact with a mating terminal inserted therebetween; and
a pair of connecting members rotatably connecting the pair of terminals to the housing such that the terminals can be rotated about an axis of the connecting member, the axis of the connecting member extending along the height direction of the housing.

2. The connector according to claim 1, wherein each of the terminals is a rigid conductive component adapted to transmit current, and a contact force between the terminals and the mating terminal is provided by the elastic arms of the housing.

3. The connector according to claim 1, wherein:
the housing has front and rear ports opposite in a longitudinal direction of the housing;
each of the terminals includes a front end portion and a rear end portion located in the front port and the rear port, respectively; and
each of the elastic arms includes a front elastic arm and a rear elastic arm corresponding to the front end portion and rear end portion of each terminal, respectively.

4. The connector according to claim 3, wherein at least one of:
the front elastic arms of the pair of side walls are pressed on the outer sides of the front end portion of the pair of terminals and apply a first contact pressure on the front end portions of the pair of terminals; or
the rear elastic arms of the pair of side walls are respectively pressed on the outer sides of the rear end portions of the pair of terminals and apply a second contact pressure on the rear end portions of the pair of terminals.

5. The connector according to claim 4, wherein at least one of:
first avoidance grooves are formed on front sides of the top wall and bottom wall of the housing to accept two longitudinal side edges of the mating terminal, allowing the first mating terminal with a width greater than the height of the housing to be inserted into the front port of the housing; or
second avoidance grooves are formed on rear sides of the top wall and bottom wall of the housing to accept two longitudinal side edges of another mating terminal, allowing it with a width greater than the height of the housing to be inserted into the rear port of the housing.

6. The connector according to claim 1, wherein:
each terminal comprises multiple terminal laminations stacked in the height direction of the housing; and
a through hole is formed in each of the terminal laminations that allows the connecting member to pass through.

7. The connector according to claim 6, wherein:
the number and thickness of terminal laminations in the terminal are determined based on the magnitude of electrical current that needs to be transmitted by the connector; and
the number of terminal laminations in the terminal is not less than three.

8. The connector according to claim 1, wherein:
slot holes are formed in the top wall and bottom wall of the housing and permit the connecting member to pass therethrough; and
a size of the slot hole in the transverse direction of the housing is larger than a diameter of the connecting member to allow the connecting member to move relative to the housing in the transverse direction.

9. The connector according to claim 8, wherein the connecting member includes a rotating shaft part with smooth surface, the rotating shaft part passes through the through hole enabling a respective one of the terminals to rotate around the axis of the rotating shaft part.

10. The connector according to claim 9, wherein:
the connecting member further includes a head and a threaded portion located at both ends of the rotating shaft part, and the connector further includes a nut for connecting to the threaded portion of the connecting member; and
the head of the connecting member is positioned on the top wall of the housing, and the threaded portion of the connecting member extends out from the bottom wall of the housing and is threaded to the nut.

11. The connector according to claim 10, further comprising at least one of:
an upper washer sleeved on the rotating shaft part of the connecting member and arranged between the top wall of the housing and a top surface of the terminal; or
a lower washer sleeved on the rotating shaft part of the connecting member and arranged between the bottom wall of the housing and a bottom surface of the terminal.

12. A connector assembly, comprising:
an insulation housing having at least one containment chamber; and
at least one connector installed in at least one containment chamber of the insulation housing, including:
a housing, having:
a top wall;
a bottom wall opposite the top wall in a height direction of the housing; and
a pair of side walls opposite one another in a transverse direction of the housing, each side wall having an elastic arm;
a pair of terminals arranged in the housing and facing each other in the transverse direction of the housing, the pair of terminals having inner sides facing each other and outer sides opposite to each other in the transverse direction, each elastic arm of the pair of side walls pressing on respective ones of the outer sides of the pair of terminals and adapted to bias the pair of terminals into electrical contact with a mating terminal inserted therebetween; and
a pair of connecting members rotatably connecting the pair of terminals to the housing such that the respective terminal can be rotated about an axis of the connecting member, the axis of the connecting member extending along the height direction of the housing.

13. The connector assembly according to claim 12, wherein:
the insulation housing has front and rear walls opposite to each other in its longitudinal direction;
at least one first opening is formed in the front wall of the insulation housing and is in communication with at least one containment chamber, the at least one first opening adapted to allow a first mating terminal mated with a front end of the connector to be inserted into the containment chamber through the first opening; and
at least one second opening is formed in the rear wall of the insulation housing and is in communication with at least one containment chamber, the at least one second opening adapted to allow a second mating terminal mated with a rear end of the connector to be inserted into the containment chamber through the second opening.

14. The connector assembly according to claim 12, wherein the insulation housing has multiple containment chambers arranged side by side in one or more rows.

15. The connector assembly according to claim 13, wherein:
the insulation housing has a top opening, and the connector is installed into the containment chamber through the top opening; and
the connector assembly further comprises a top cover installed on the top opening of the insulation housing and covering the top opening of the insulation housing.

16. The connector assembly according to claim 15, wherein:
the insulation housing has two opposite side walls in its transverse direction, and a snapping slot is formed on each of two side walls of the insulation housing; and
protrusions are formed on both sides of the top cover and engage with the snapping slots to fix the top cover to the insulation housing.

17. The connector assembly according to claim 15, wherein:
avoidance grooves are formed on the top cover and the bottom wall of the insulation housing, the avoidance grooves are in communication with the first opening and extend a predetermined length along the longitudinal direction of the insulation housing; and
the avoidance grooves are adapted to receive longitudinal side edges of the first mating terminal enabling the first mating terminal having a width greater than the height of the insulation housing to be inserted into the containment chamber.

18. The connector assembly according to claim 13, wherein a guide portion is formed on the outer side of the front wall of the insulation housing and defines a guide slope for guiding the first mating terminal into the first opening of the insulation housing.

19. The connector assembly according to claim 16, wherein two connecting ears are formed on the outer sides of two side walls of the insulation housing and are adapted to connect to an installation panel to fix the insulation housing to the installation panel.

20. The connector assembly according to claim 12, wherein a lateral dimension of the containment chamber in the insulation housing is larger than a lateral dimension of the housing of the connector, allowing the connector to float in the containment chamber of the insulation housing.
